(19) United States
(12) Patent Application Publication
(10) Pub. No.: US 2009/0179338 A1
(43) Pub. Date: Jul. 16, 2009

(54) ACTIVE WEATHER STATION SYSTEM

(76) Inventor: Aymeric Le Cottier, Hong Kong (CN)

Correspondence Address: OSTROLENK FABER GERB & SOFFEN, 1180 AVENUE OF THE AMERICAS, NEW YORK, NY, 100368403, US

(21) Appl. No.: 12/013,014

(22) Filed: Jan. 11, 2008

(51) Int. Cl. B01F 3/04; G01W 1/02

(52) U.S. Cl. 261/129; 73/170.16

(57) ABSTRACT

An active weather system includes a main weather station unit, a humidifier unit and a remote sensor. The main weather station unit has a main housing with a humidity sensor that detects a level of humidity in an area surrounding the main weather station unit. The humidifier unit includes a housing with a nest for removably mounting the main housing. The humidifier unit also includes a water tank and a humidifier. The humidifier vaporizes water from the water tank when the humidity sensor detects a level of humidity lower than a preset level. Electrical contacts in the nest of the humidifier housing and the main weather station electrically connect the units when the main housing is mounted in the nest. The remote sensor may be placed away from the main unit, such as outdoors, to sense temperature and/or humidity in its environment. The remote sensor includes a transmitter, which sends the temperature and/or humidity information it detects to the main weather station unit.

### BACKGROUND OF THE INVENTION

1. Field of the Invention

The present invention relates to a weather station system providing weather information determined from a continuous sampling of environmental data.

2. Description of the Related Art

A conventional, typically domestic use, weather station is a battery operated electronic device that calculates forecasts of weather based on a continuous sampling of environmental data and that displays its weather forecasts, typically in a form including icons or symbols, e.g., symbols for sunshine, clouds, rain and snow, typically on an LCD screen. Weather is typically forecast for a period of 8-24 hours, and with an accuracy of about 70%. Weather stations may conventionally incorporate other functions, for example, a clock and/or a calendar. Examples of functions and information supplied by weather stations include:
Perpetual Calendar up to year 2069
Auto synchronizing radio controlled clock.
12/24 hour time display selectable.
Local temperature and humidity display.
Animated weather forecast symbols.
Barometric Pressure Bar chart, current and past 12 hours barometric pressure reading.
Receivers and monitors temperature and humidity from up to 3 remote sensors via RF technology of 433 MHZ (One Wireless Thermo Sensor Included).
Temperature and humidity trend indicator.
Maximum/Minimum Memory for Indoor/Outdoor Temperature and Humidity.
Days of the week selectable in 8 Languages.
Lunar and tidal phases.
User selectable ° C. or ° F.

However, conventional weather stations only display the weather forecasts passively, i.e., they cannot modify the environmental conditions including temperature and hygrometry, within the area, such as a room, where the station is located.

In contrast, an active weather system of the invention includes a main weather station unit, similar to a passive station, along with a humidifier unit. An active weather station defines a comfort zone for people in its vicinity according to current ambient temperature and humidity. The comfort zone condition is typically displayed e.g., on an LCD screen, on a device often using icons that are easy to understand. When the “active” weather station detects that the ambient environment is out of the comfort zone, the built-in humidity maker will be activated to moisturize the environment.

### SUMMARY OF THE INVENTION

An active weather station disclosed herein comprises a main weather station unit including a main housing and a humidity sensor housed within the main housing. The humidity sensor detects a level of humidity within an area surrounding the main weather station unit.

The humidifier unit includes a humidifier housing. In a preferred aspect, the humidifier housing includes a nest that is shaped and adapted to removably mount the main housing of the main weather station unit therein although once assembled as a combined unit, the main and humidifier housings might not be separable. The humidifier unit includes a water tank and a humidifier. The humidifier vaporizes water from the water tank to produce water vapor when the humidity sensor preferably in the main unit detects an ambient level of humidity lower than a preset level. At least one electrical contact in the nest of the humidifier housing electrically connects the main weather station unit to the humidifier unit when the main housing is mounted in the nest of the humidifier housing.

In another aspect, the main housing of the main weather station unit and the humidifier housing are integrated as one unit avoiding need for a nest.

In another aspect, the active weather system also includes a remote sensor that may be placed outdoors or in another environment than the main unit and is operable to sense an outdoor temperature or the temperature in the other environment and/or to sense the humidity and possibly the barometric pressure in the other environment. The remote sensor includes a transmitter which transmits the detected outdoor or environmental temperature to the main weather station unit.

In a further aspect, the main weather station unit also includes a display that receives and displays information related to functions of the humidifier unit, the detected outdoor or environment temperature and other data.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation in the Figures of the accompanying drawings in which like references denote like or corresponding parts, and in which:

FIG. 1 shows a perspective view of an active weather station including a main weather station unit nested within a humidifier unit.

FIG. 2 shows a perspective view of a different configuration of an active weather station including a main weather station unit nested within a humidifier unit.

FIG. 3 shows a perspective view of the main weather station unit shown in FIG. 1.

FIG. 4 shows a perspective view of the main weather station unit shown in FIG. 2.

FIG. 5 shows a perspective view of the humidifier unit shown in FIG. 1.

FIG. 6 shows a perspective view of the humidifier unit shown in FIG. 2.

FIG. 7 schematically shows a remote sensor to be associated with the main weather station unit.

### DETAILED DESCRIPTION OF THE PREFERRED EMBODIMENTS AND THE DRAWINGS

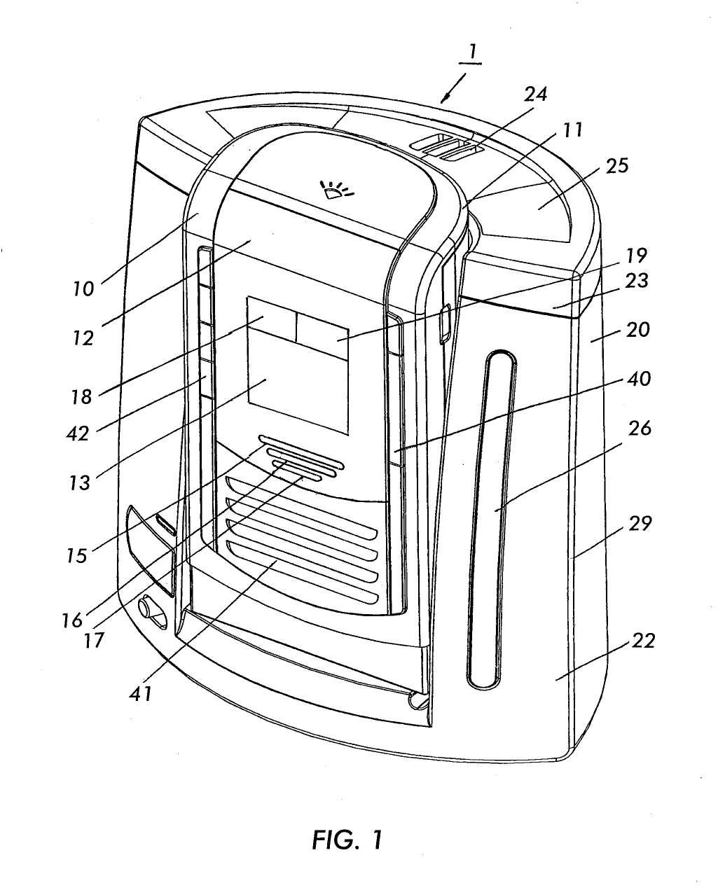

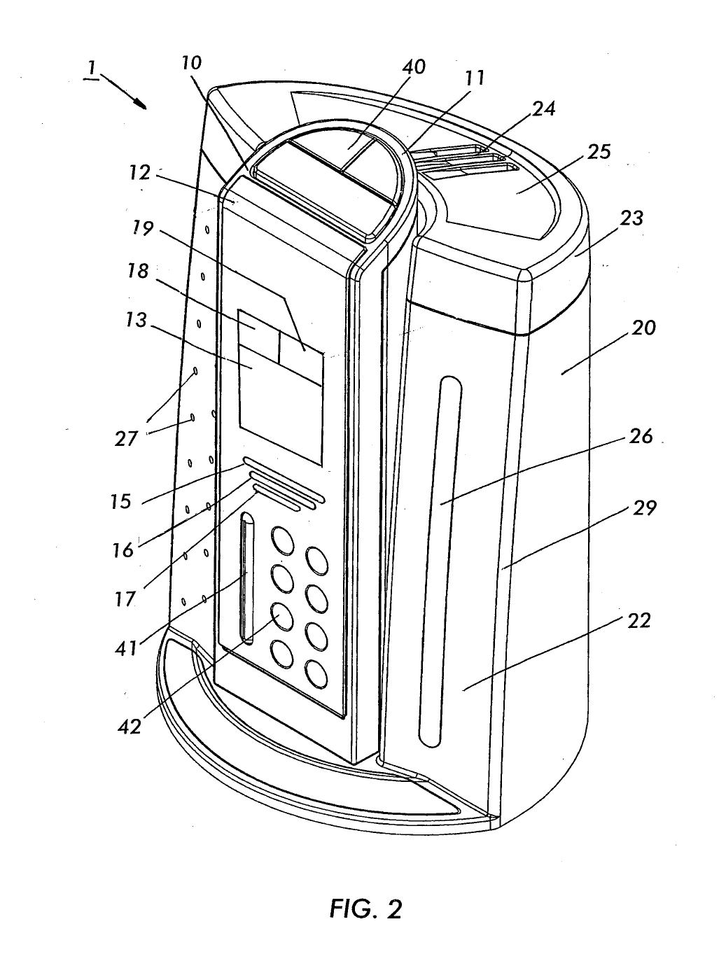

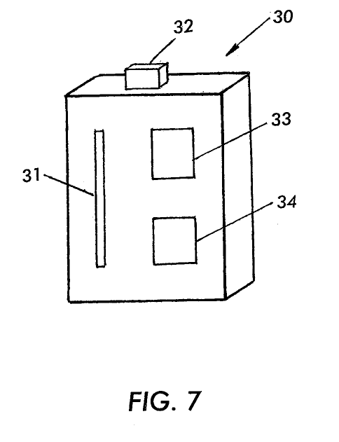

As shown in FIGS. 1 and 2, an active weather system 1 includes a main weather station unit 10 and a humidifier unit 20. A remote sensor 30, shown in FIGS. 7a and 7b, is also provided with the active weather system 1. The remote sensor need not be physically connected to either unit 10 or 20 or be in their immediate vicinity.

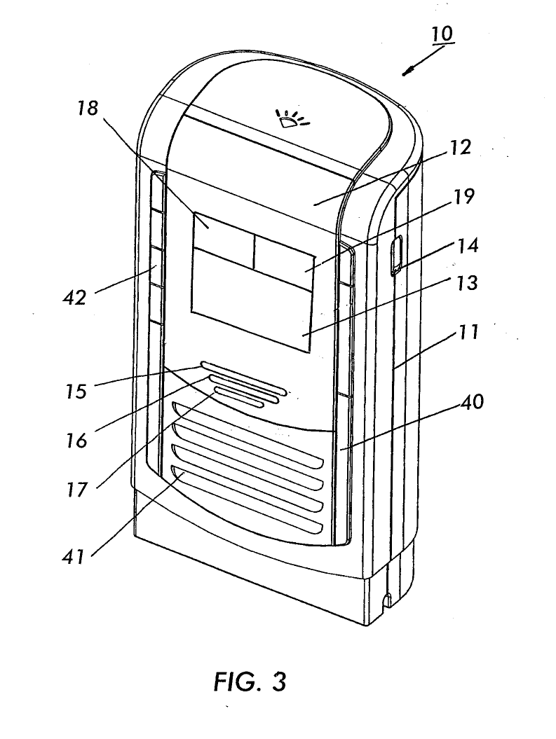

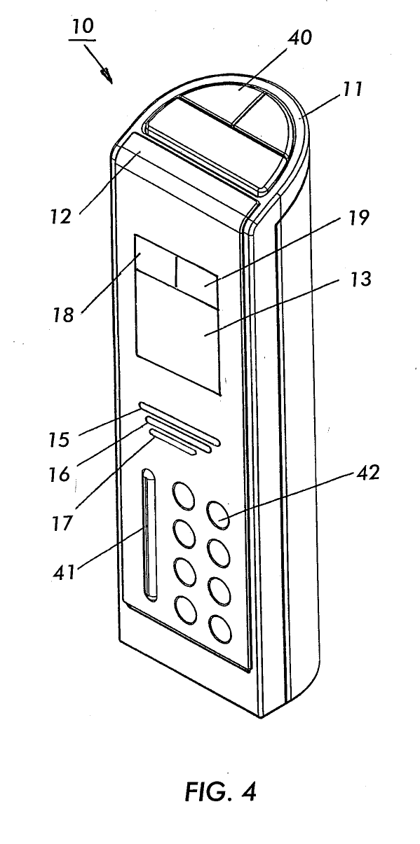

As shown in FIGS. 3 and 4, the weather station unit 10 preferably includes a half-cylindrical housing 11, which contains a main control unit 12, an LCD display 13, an alphanumeric display, or another conventional weather data display device, a barometer 15, an indoor temperature sensor 16 and a humidity sensor 17. Elements 15, 16 and 17 are conventionally available components. Barometer 15, indoor temperature sensor 16 and humidity sensor 17 continuously measure and sample indoor environment in the vicinity of the main unit 10 to compile the environmental data. The measured data is then displayed conventionally on the LCD display 13.

Housing 11 further contains the main control unit 12, which receives the sensed environmental data from barometer 15, indoor temperature sensor 16, humidity sensor 17 and a remote sensor 30 (described below). Main control unit 12 executes software to calculate a weather forecast based on the received environmental data and to display the calculated weather forecast on the LCD display 13. LCD display 13 preferably displays the calculated weather forecast in a form of iconic symbols, which are easy to understand.

Any of an alarm clock 18, a radio 41 and a calendar 19 may also be provided within the housing 11 and are displayed on the housing 11. Main control unit 12 controls functions of the clock, the radio and the calendar. A main weather station key section 40 is located at the top of the weather station unit 10 in FIG. 4 and at the front of the unit in FIG. 3. The key section includes keys allowing a user to manually set up features of the clock, the display, the alarm and the calendar. Other operational keys may also be included. Further, a plurality of radio control keys 42 and a radio speaker portion may also be provided at the front of the weather station unit. Finally, a plurality of control keys may also be provided on a back key section (not shown) located at a back panel of the weather station unit 10. Back key section may include keys allowing a user to set a temperature alert preference, the height of the user's location from the sea level and other optional features that may make the unit more useful. LCD display 13 displays the clock, the calendar, the selected radio channel in accordance with the selection entered by a user via the various keys.

Weather station unit 10 is preferably battery operated. A battery compartment 14 in the housing 11 (shown in FIG. 3) houses the battery of the weather station unit. A low battery indication may display on the LCD display 13 to alert a user of the low battery.

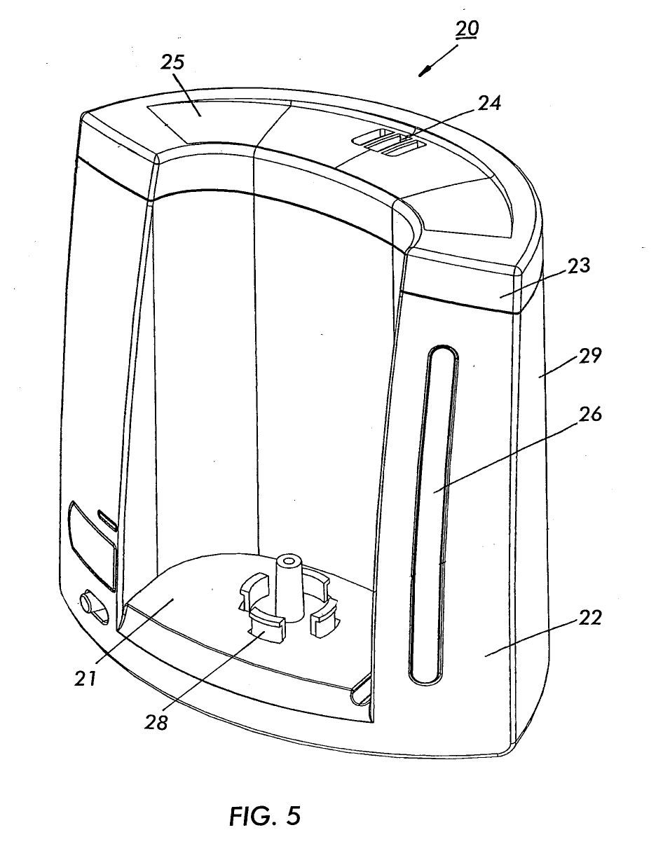

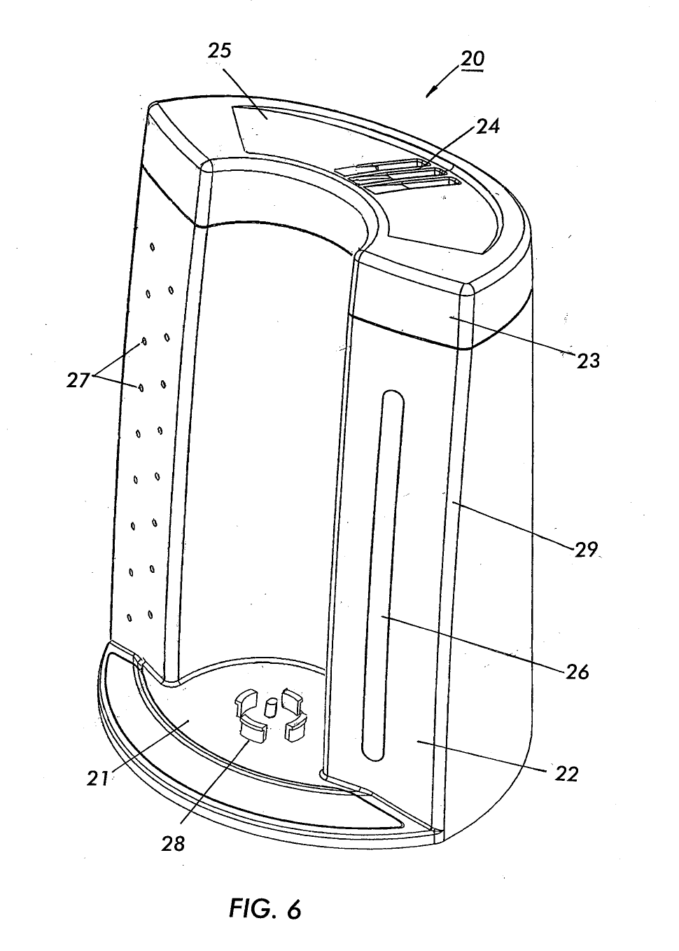

As shown in FIGS. 5 and 6, the humidifier unit 20 includes a housing 29 having a semi-cylindrical nest 21 in which the weather station unit is removably nested. A nested weather station unit is shown in FIGS. 1 and 2. In an alternative embodiment, the nested together weather station unit and humidifier could be combined and even integrated as a single unit not intended to be separated after its assembly.

The humidifier unit 20 includes a humidifier 23 which includes a water tank 22. Humidifier 23 is preferably located internally of and at the top of the humidifier unit 20 and is covered with a grate 24 located at the top lid 25 of the humidifier unit 20. The humidifier preferably includes a ceramic plate (not shown), which, when operated, vibrates at ultrasonic frequency to vaporize water guided from the water tank via a fabric filter through capillary action. This construction of a vaporizer humidifier operable for producing water vapor is conventional. Vaporized water is emitted through the grate 24 at the top of the unit. The humidifier preferably emits about 60 ml/hr but can have a different output capacity. The top lid 25 can be opened to refill the tank with water.

A water level indicator 26 is preferably provided on a surface of the humidifier unit 20 to show the water level.

Humidifier unit 20 may include a plurality of LEDs or lights 27 (shown in FIGS. 2 and 6), which illuminate when the humidifier is vaporizing water. In the preferred embodiment, LED lights 27 blink and the vaporizing function stops when the water level in the tank is low. In addition to indicating the low water level on the water indicator 26, the low water level may be indicated by an appropriate symbol displayed on the LCD display 13.

Humidifier unit 20 is preferably powered by an external AC/DC power adapter (not shown).

Humidifier unit 20 further includes a mounting fixture 28 (shown in FIGS. 5 and 6) located at the bottom or support surface of the nest 21. When the main weather station unit 10 is positioned in the nest 21 of the humidifier unit 20, the two units become electrically connected via the fixture 28 and a complementary fixture in the main housing. There are electrical contacts in these fixtures which are jointed when the main unit is in the humidifier unit nest. This thereafter allows a user to control settings of the humidifier unit 20 using the control keys of the weather station unit 10. Additionally, this separable electrical connection between the humidifier unit 20 and the weather station unit 10 allows the LCD display 13 to display information related to the functions of the humidifier unit 20.

A predetermined ambient humidity value range is preset for the humidifier unit 20 either at the time of manufacture and/or by the user. Whenever an ambient humidity within the indoor area surrounding the active weather system of the invention is detected by the humidity sensor 17 of the weather station unit 10 as falling below a predetermined value or range, the weather station unit 10 sends an electrical signal to the humidifier unit 20 to activate the humidifier 23. Humidifier 23 then operates to emit water vapor, as described above, humidifying the indoor area for a predetermined period of time. After the humidifier stops vaporizing water, the weather station unit 10 waits for a brief period of time to allow the ambient humidity in the area to stabilize and then samples the ambient humidity again. If the sensed humidity is still below the preset value range, the weather station unit 10 sends another electrical signal to the humidifier unit 20 to again generate water vapor in the described fashion.

A remote sensor positionable at a location remote from the weather station unit, and described below, also will sense the humidity in the environment surrounding the remote sensor. If the remote sensor detects a humidity level in its surroundings that is below a preset level established for the remote sensor, it will transmit that information to the main weather station unit, which will then cause the humidifier to operate until the remote sensor detects a humidity level above the preset level for the remote sensor. Therefore, the detected humidity level at either sensor may trigger the humidifier to produce water vapor.

A user may choose to operate the humidifier regardless of the humidity level sensed by the humidity sensor 17. An appropriate key for such manual operation may be provided in the main weather station key section 40.

A remote sensor 30, shown in FIG. 7 includes either or both of an outdoor thermometer 31 and a humidity sensor 33 and possibly also an outdoor barometer 34, plus a transmitter 32. Transmitter 32 is preferably a radio frequency transmitter. Remote sensor 30 is typically mounted outdoors or in an environment other than that surrounding the unit 10 to continuously sample the outdoor or environmental temperature with the outdoor thermometer 31, humidity with the humidity sensor 33, pressure with the barometer 34, etc. The components 31, 33 and 34 are internally in the remote sensor 30 connected to the transmitter 32. The various noted data sensed by the sensor are transmitted by the radio frequency transmitter 32 to the main weather station unit 10, which receives the data and displays it on the LCD display 13. The remote sensor is preferably battery operated.

For the convenience of the reader, the above description has focused on representative samples of all possible embodiments, samples that teach the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

We claim:

1. An active weather system comprising:
a main weather station unit having a main housing;
a humidity sensor housed within the main housing, the humidity sensor being operable to detect a level of humidity within an area surrounding the main weather station unit;
a humidifier unit having a humidifier housing including a nest, the main housing of the main weather station unit being in the nest of the humidifier housing;
the humidifier unit having a humidifier, the humidifier being operable to vaporize water and to produce water vapor when the humidity sensor detects a level of humidity lower than a preset level of humidity;
the humidifier unit further having an electric contact and the main weather station unit having a complementary electric contact for electrically connecting the main weather station unit to the humidifier unit when the main housing is mounted in the nest of the humidifier housing, wherein the electrical connection enables information and operating instruction to be sent between the main weather station unit and the humidifier.

2. The active weather system according to claim 1, further comprising a remote sensor having at least one of a temperature sensor operable to detect temperature and a humidity sensor operable to detect humidity around the remote sensor, the remote sensor further having a transmitter operable to transmit detected at least one of temperature and humidity to the main weather station unit.

3. The active weather system according to claim 1, wherein the main weather station unit further comprises a display operable to receive and display information related to functions of the humidifier unit.

4. The active weather system according to claim 2, wherein the main weather station unit further comprises a second temperature sensor at the main housing and operable to continuously detect temperature around the second temperature sensor, the display of the main weather station unit being operable to receive and display temperature detected by the second temperature sensor.

5. The active weather system according to claim 4, wherein the main weather station unit further comprises a main control unit operable to receive weather data from the second temperature sensor, the humidity sensor and the remote sensor, the main control unit being further operable to calculate a weather forecast based on the received weather data, the display of the main weather station being operable to receive and display the calculated weather forecast.

6. The active weather system according to claim 1, wherein the weather station unit is removably mounted in the nest of the humidifier housing.

7. The active weather system according to claim 1, further comprising a first set of operator keys at the weather system and operable to control the humidifier unit.

8. The active weather system according to claim 1, further comprising a clock at the main housing, a display of the main weather station being operable to receive and display information from the clock.

9. The active weather system according to claim 8, further comprising a second set of operator keys operable to control the clock.

10. The active weather system according to claim 1, further comprising a radio at the main housing.

11. The active weather system according to claim 10, further comprising a third set of operator keys operable to control the radio.

12. The active weather system according to claim 1, wherein the humidifier unit further includes a water supply and a device for vaporizing water from the water supply.

13. The active weather system according to claim 1, wherein the main weather station unit further comprises a second temperature sensor at the main housing and operable to continuously detect temperature around the second temperature sensor, the display of the main weather station unit being operable to receive and display temperature detected by the second temperature sensor.

14. An active weather system comprising:
a main weather station unit having a main housing;
a humidity sensor housed within the main housing, the humidity sensor being operable to detect a level of humidity within an area surrounding the main weather station unit;
a humidifier unit having a humidifier housing, the main housing of the main weather station unit and the humidifier housing being one housing;
the humidifier unit having a humidifier, the humidifier being operable to vaporize water and to produce water vapor when the humidity sensor detects a level of humidity lower than a preset level of humidity;
the humidifier unit being electrically connected to the main weather station unit, wherein the electrical connection enables information and operating instruction to be sent between the main weather station unit and the humidifier.

15. The active weather system according to claim 14, further comprising a remote sensor having at least one of a temperature sensor operable to detect temperature and a humidity sensor operable to detect humidity around the remote sensor, the remote sensor further having a transmitter operable to transmit detected at least one of temperature and humidity to the main weather station unit.
